(19) United States
(12) Patent Application Publication
(10) Pub. No.: US 2006/0007384 A1
(43) Pub. Date: Jan. 12, 2006

(54) Liquid crystal display device and electronic apparatus

(76) Inventor: Hayato Kurasawa, Nagano (JP)

Correspondence Address: HARNESS, DICKEY & PIERCE, P.L.C., P.O. BOX 828, BLOOMFIELD HILLS, MI, 48303, US

(21) Appl. No.: 11/156,970

(22) Filed: Jun. 20, 2005

(30) Foreign Application Priority Data
Jul. 7, 2004 (JP) 2004-200549

(51) Int. Cl. G02F 1/1339

(52) U.S. Cl. 349/155

(57) ABSTRACT

A liquid crystal display device includes a pair of opposing substrates; a liquid crystal layer disposed between the pair of substrates, the liquid crystal layer being formed of liquid crystal which has a negative dielectric anisotropy and which is vertically aligned in an initial alignment state; pixels disposed in a matrix within an area of one of the pair of substrates, each pixel including a pixel electrode, a gap between the pixel electrode of the pixel and the pixel electrode of an adjacent pixel, a switching element connected to the pixel electrode, and a metal line connected to the switching element, the pixels including a first pixel and a second; a columnar spacer that separates the opposing substrates, the spacer being disposed at a position of the first pixel that corresponds to the gap of the first pixel or in overlap with the switching element of the first pixel; and a first protrusion having a height that is less than the height of the spacer and that is disposed at a position of the second pixel that corresponds to the position of the first pixel where the spacer is disposed.

### BACKGROUND OF THE INVENTION

1. Technical Field

The present invention relates to a liquid crystal display device and an electronic apparatus, and, more particularly, to a technology which provides a display having a wide viewing angle range and a high contrast in a liquid crystal display device using homeotropic liquid crystal.

2. Related Art

A transflective liquid crystal display device having a reflection mode and a transmission mode is known as a liquid crystal display device. A transflective liquid crystal display device of a type in which a liquid crystal layer is disposed between an upper substrate and a lower substrate and a reflective film (a metallic film, such as an aluminum film, having a window for transmitting light) is disposed at the inner surface of the lower substrate and functions as a transflective plate has been proposed. In this case, in the reflection mode, incident outside light from the upper substrate passes through the liquid crystal layer, is then reflected by the reflective film, then passes through the liquid crystal layer again, and then exits from the upper substrate to the outside, as a result of which the light is used for a displaying operation. In contrast, in the transmission mode, incident light emitted from a backlight and traveling to the lower substrate passes through the liquid crystal layer from the window of the reflective film, and then exists from the upper substrate to the outside, as a result of which the light is used for a displaying operation. Therefore, of a reflective film formation area, an area where the window is formed corresponds to a transmissive display area and the area where the window is not formed corresponds to a reflective display area.

However, the related transflective liquid crystal display device has a problem in that the viewing angle is narrow in transmissive display. This is because optical design freedom is small due to a restriction that reflective display must be performed with only one polarizer at an observer side since the transflective plate is disposed at the inner surface of a liquid crystal cell so as to prevent parallax. To overcome this problem, Jisaki et al. discloses a novel liquid crystal display device using homeotropic liquid crystal in Japanese Unexamined Patent Application Publication No. 2002-350853 and “Development of transflective LCD for high contrast and wide viewing angle by using homeotropic alignment,” Asia Display/IDW '01, pp. 133-136(2001). The features are as follows:
(1) A vertical alignment (VA) mode in which liquid crystal having a negative dielectric anisotropy are aligned vertically with respect to a substrate and tilted by application of a voltage is used;
(2) A multi-gap structure in which the thickness of a portion of a liquid crystal layer at a transmissive display area and the thickness of a portion of the liquid crystal layer at a reflective display area (cell gaps) are different is used (refer to, for example, Japanese Unexamined Patent Application Publication No. 11-242226; and
(3) The transmissive display area has a regular octagonal shape and a protrusion is disposed at the center of the transmissive display area on an opposing substrate so that the liquid crystal is tilted in all directions in this area. In other words, an “alignment segmentation structure” is used.

As described above, in the liquid crystal display device using homeotropic liquid crystal (having a negative dielectric anisotropy) which is subjected to alignment segmentation alignment without rubbing, it is necessary to control the direction in which the liquid crystal molecules are tilted as a result of distorting an electrical field in a pixel area by forming an opening in a portion of an electrode in the pixel area or a dielectric protrusion on a portion of the electrode in the pixel area. If the liquid crystal alignment is not sufficiently controlled, the liquid crystal molecules are tilted in random directions while domains of certain sizes are maintained in a plane. In such a state, an area having a different viewing angle property is formed in a portion of the display area. As a result, the display appears uneven.

In the related liquid crystal display device, spherical spacers used for maintaining the thickness of the liquid crystal layer are randomly disposed in any location in the liquid crystal layer. Therefore, the liquid crystal is brought out of alignment, causing the display to appear uneven. When one pixel area is defined by a pixel electrode, an area between the pixel electrode and an adjacent pixel electrode, a switching element connected to the pixel electrode, and a metallic wire connected to the switching element, it is desirable that, in the homeotropic liquid crystal in an alignment segmentation structure, any effect on the alignment of the liquid crystal in a pixel electrode plane be minimized by forming a columnar space (primarily formed of resin) at the area between the adjacent pixels. In addition, when the columnar spacer is disposed so as to overlap the switching element, it is possible to reduce the electrical field generated from the switching element, thereby preventing the liquid crystal from becoming misaligned.

Since bubbles tend to be formed in a liquid crystal panel as the number of columnar spaces per unit area increases, the columnar spaces cannot be disposed in all pixel areas in a plane, particularly, in a high-definition liquid crystal display device. In this case, a pixel area having a columnar space disposed thereat and the other pixel areas not having columnar spaces disposed thereat produce different liquid crystal alignments, thereby giving rise to differences in display characteristics in a plane. In addition, for a liquid crystal display device including switching elements, the liquid crystal is brought out of alignment by an electrical field generated from the switching elements in pixel areas where columnar spaces are not disposed. This deteriorates display quality.

### SUMMARY

An advantage of the invention is that it provides a highly reliable liquid crystal display device which provides a higher display quality and a high definition.

A liquid crystal display device according to a first aspect of the invention comprises a pair of opposing substrates and a liquid crystal layer disposed between the pair of substrates, the liquid crystal layer being formed of liquid crystal which has a negative dielectric anisotropy and which is vertically aligned in an initial alignment state. At least one columnar spacer is disposed at at least one of the substrates for separating the opposing substrates. Pixel areas are disposed in a matrix at either one of the pair of substrates in a plane thereof, each pixel area including a pixel electrode, a gap between the pixel electrode and an adjacent pixel electrode, a switching element connected to the pixel electrode, and a metallic line connected to the switching element. The spacer is disposed in at least one of the gaps or so as to overlap at least one of the switching elements in at least one of the pixel areas. At least one first protrusion having a height that is less than the height of the spacer is disposed in at least one of the pixel areas where the spacer is not provided. The location where the spacer is disposed and the location where the first protrusion is disposed in the respective pixel areas are in correspondence with each other.

According to the first aspect of the invention, the term “pixel area” does not refer to an area including only a pixel electrode. It refers to an area also including a signal line and an active element associated with one pixel electrode and a portion between the pixel electrode and an adjacent pixel electrode.

In this structure, since the number of columnar spacers can be reduced to the minimum required by disposing at least one columnar spacer only at at least one of the predetermined pixel areas in the display surface of the liquid crystal display device, it is possible to prevent bubbles from being produced in the liquid crystal layer particularly, at a low temperature. Hitherto, a difference had occurred between the liquid crystal alignment state of a pixel area where a columnar spacer is not disposed and that of a pixel area where a columnar spacer is disposed due to the influence of the columnar spacer, thereby reducing the display quality.

According to the structure, in the pixel area or areas where a columnar spacer or columnar spacers are not disposed, instead of the columnar spacer or columnar spacers, a protrusion or protrusions formed of, for example, resin is/are disposed substantially at a location or locations in correspondence with where the columnar spacer or columnar spacers are disposed in order to control the liquid crystal alignment. By making similar the influence of the columnar spacer or columnar spacers on the liquid crystal alignment and the influence of the first protrusion or first protrusions on the liquid crystal alignment, it is possible to reduce the difference between the liquid crystal alignment states at the pixel areas regardless of whether or not a columnar spacer is provided. Therefore, a high quality, highly reliable liquid crystal display device can be provided.

It is preferable that an area of an area where the spacer is disposed and an area of an area where the first protrusion is disposed be substantially the same.

The effect of the protrusion or protrusions on liquid crystal alignment control is greatly related to the area or areas where the protrusion or the protrusions are formed. The aforementioned structure makes it possible to further reduce the difference between the influence of the columnar spacer or columnar spacers on the liquid crystal alignment and the influence of the first protrusion or first protrusions on the liquid crystal alignment.

It is preferable that the spacer and the first protrusion be disposed on the same substrate.

The aforementioned structure makes it possible to make similar the influence of the columnar spacer or columnar spacers on the liquid crystal alignment and the influence of the first protrusion or first protrusions on the liquid crystal alignment.

A plurality of the columnar spacers and the first protrusions may be disposed in one pixel area.

It is desirable that the columnar spacer or columnar spacers and the first protrusion or first protrusions be formed so as to overlap the switching elements in plan view. It is more desirable to directly dispose the columnar spacer or columnar spacers and the first protrusion or first protrusions on the switching elements.

In a structure in which switching elements are provided, distortion of an electrical field generated from the switching elements destroys the symmetry of the electrical field in the liquid crystal layer and is thus a major cause of disturbing the liquid crystal alignment. By disposing the columnar spacer or columnar spacers and the first protrusion or first protrusions so as to overlap the switching elements, it is possible to reduce the distortion of the electrical field. The aforementioned structure makes it possible to reduce any disturbance in the liquid crystal alignment, such as disclination, caused by the switching elements, thereby providing a high display quality. In addition, since the switching element or switching elements are covered with the first protrusion or first protrusions formed of, for example, resin, the first protrusion or first protrusions act as protective layers for the switching element or switching elements, thereby preventing the switching element or switching elements from becoming damaged due to external pressure. Therefore, it is possible to provide a highly reliable liquid crystal display device which withstands pressure very well and which generates little bubbles.

Second protrusions may be disposed at areas other than the areas where the first protrusions are disposed at the pixel areas, that is, on pixel electrodes or metallic lines connected to switching elements. Unlike the first protrusion or first protrusions disposed only at the pixel area or pixel areas where columnar spacer or columnar spacers are not disposed, the second protrusions having shapes that are similar to those of the first protrusion or first protrusions are disposed at all of the pixel areas used for a displaying operation regardless of whether or not the columnar spacer or columnar spacers or the first protrusion or first protrusions are disposed. The first and second protrusions are formed of the same material and have the same height. When the first and second protrusions are formed on the same substrate, it is desirable that the first and second protrusions be formed by the same process.

The second protrusions are formed for controlling liquid crystal alignment. Forming the first and second protrusions at the same time can reduce cost burden.

It is desirable that the second protrusions be disposed so as to overlap the metallic lines, such as scanning lines or signal lines, connected to the switching elements. A relatively high voltage applied to the metallic lines causes the electrical field generated from the metallic lines to symmetrically distort the electrical field in the liquid crystal layer and thus to disturb the liquid crystal alignment. The aforementioned structure can reduce the distortion of the electrical field from the metallic lines by blocking the electrical field. Covering substantially the entire metallic lines with the protrusions makes it possible to maximally reduce the threshold distortion in the liquid crystal layer, or covering only portions of the metallic lines with the protrusions makes it possible to fix the location where disclination of the liquid crystal alignment occurs to a particular location.

The liquid crystal display device according to the first aspect may be such that the first protrusion/first protrusions or the first and second protrusions are provided, a transmissive display area and a reflective display area are provided in one pixel area, and a liquid crystal layer thickness adjusting layer for making the thickness of a portion of the liquid crystal layer at the reflective display area smaller than the thickness of a portion of the liquid crystal layer at the transmissive display area is disposed between the liquid crystal layer and at least one of the pair of substrates.

In the transflective liquid crystal display device comprising the liquid crystal layer thickness adjusting layer, the columnar space or columnar spaces are disposed so as to overlap the liquid crystal layer adjusting layer. The switching elements are frequently disposed at locations overlapping the liquid crystal layer thickness adjusting layer in plan view, as a result of which the height of a portion of the liquid crystal layer in the area where the switching elements are disposed is relatively small. Therefore, the switching elements tend to be damaged by external pressure, such as push pressure. In the structure according to the first aspect of the invention, the first protrusion or first protrusions are provided, so that damage to the switching element or switching elements by external pressure occurs less frequently.

A electronic apparatus according to a second aspect of the invention comprises any one of the above-described liquid crystal display devices. Therefore, it is possible to provide at a low cost an electronic apparatus comprising a highly reliable display unit providing excellent display quality.

### BRIEF DESCRIPTION OF THE DRAWINGS

The invention will be described with reference to the accompanying drawings, wherein like numbers reference like elements, and wherein:

FIG. 1 is an equivalent circuit diagram of a liquid crystal display device according to a first embodiment of the invention;

FIG. 2 is a plan view of a dot structure of the liquid crystal display device;

FIG. 3A is a schematic plan view of the main portion of the liquid crystal display device;

FIG. 3B is a schematic sectional view of the main portion of the liquid crystal display device;

FIG. 4A is a schematic plan view of the main portion of a liquid crystal display device according to a second embodiment of the invention;

FIG. 4B is a schematic sectional view of the main portion of the liquid crystal display device according to the second embodiment of the invention;

FIG. 5A is a schematic plan view of the main portion of a liquid crystal display device according to a third embodiment of the invention;

FIG. 5B is a schematic sectional view of the main portion of the liquid crystal display device according to the third embodiment of the invention;

FIG. 6 is a perspective view of an example of an electronic apparatus in accordance with the invention.

### DESCRIPTION OF THE EMBODIMENTS

### First Embodiment

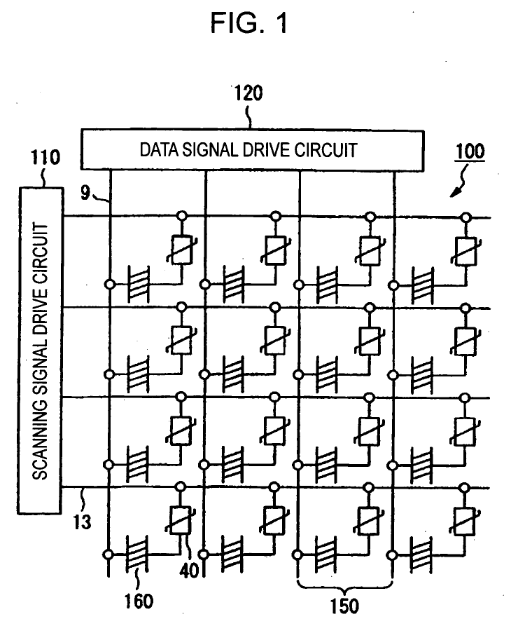

While referring to FIGS. 1 to 3, a first embodiment of the invention will be described. In the figures, each layer and each member are shown with sizes large enough to be seen, so that each layer and each member are shown using different scales.

A liquid crystal display device of the first embodiment described below is an active matrix liquid crystal display device using thin film diodes (hereunder abbreviated as “TFDs”) as switching elements, and is, in particular, a transflective liquid crystal display device which can provide a reflective display and a transmissive display.

FIG. 1 shows an equivalent circuit for a liquid crystal display device 100 according to the embodiment. The liquid crystal display device 100 includes a scanning signal drive circuit 110 and a data signal drive circuit 120. In the liquid crystal display device 100, signal lines, that is, a plurality of scanning lines 13 and a plurality of data lines 9 intersecting the scanning lines 13 are provided, with the scanning lines 13 being driven by the scanning signal drive circuit 110 and the data lines 9 being driven by the data signal drive circuit 120. In each pixel area 150, a TFD element 40 and a liquid crystal display element 160 (liquid crystal layer) are connected in series between the associated scanning line 13 and data line 9. Although, in FIG. 1, the TFD elements 40 are connected to the scanning lines 13 and the liquid crystal display elements 160 are connected to the data lines 9, the TFD elements 40 may be connected to the data lines 9 and the liquid crystal display elements 160 may be connected to the scanning lines 13.

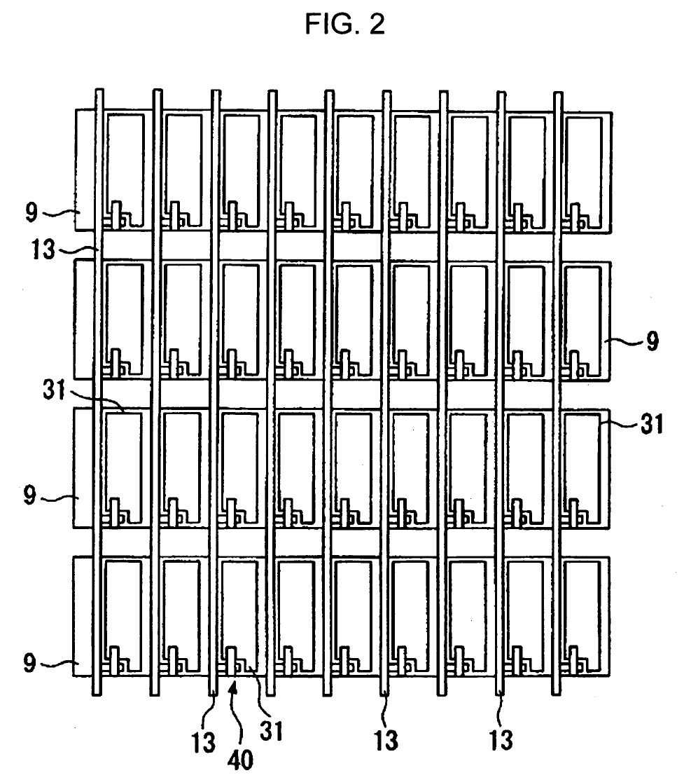

Referring to FIG. 2, the planar structure (pixel structure) of electrodes in the liquid crystal display device 100 according to the embodiment will be described. As shown in FIG. 2, in the liquid crystal display device 100 according to the embodiment, pixel electrodes 31 which are rectangular in plan view and connected to the scanning lines 13 via the TFD elements 40 are disposed in a matrix, and common electrodes 9 opposing the pixel electrodes 31 perpendicularly to the plane of the figure are disposed in stripes. The common electrodes 9 comprise the data lines and intersect the scanning lines 13 in the form of stripes. In the embodiment, an area where the associated pixel electrode 31 is provided, an area between the associated pixel electrode 31 and an adjacent pixel electrode 31, the associated TFD element 40 connected to the associated pixel electrode 31, and the associated data line 9 connected to the associated TFD element 40 is defined as one dot area. The TFD elements 40 are provided in the respective dot areas disposed in a matrix, so that a displaying operation can be performed at each dot area.

Here, the TFD elements 40 are switching elements connected to the respective scanning lines 13 and pixel electrodes 31. Each TFD element 40 has an MIM structure comprising a first conductive film whose main component is Ta, an insulating film formed on the surface of the first conductive film and whose main component is Ta₂O₃, and a second conductive film formed on the surface of the insulating film and whose main component is Cr. The first conductive films of the TFD elements 40 are connected to the scanning lines 13, and the second conductive films of the TFD elements 40 are connected to the pixel electrodes 31.

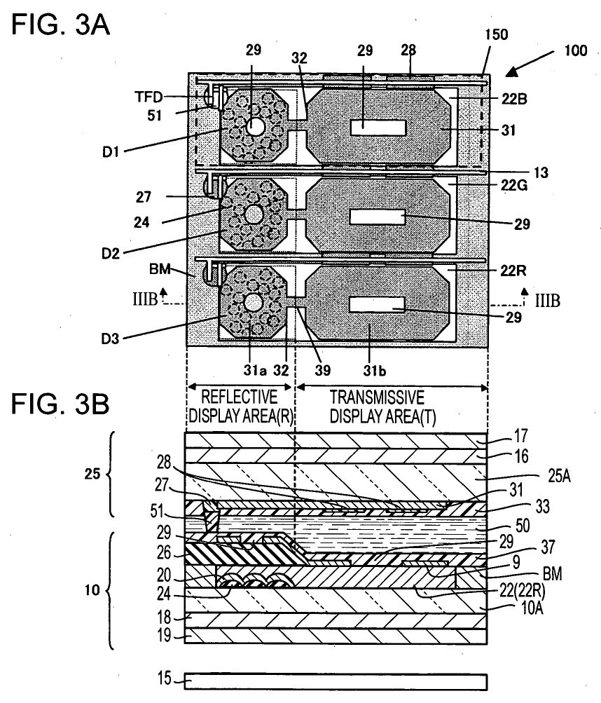

Referring to FIGS. 3A and 3B, the pixel structure of the liquid crystal display device 100 according to the embodiment will be described. FIG. 3A is a plan view of the pixel structure of the liquid crystal display device 100, and, more particularly, of the structure of the pixel electrodes 31. FIG. 3B is a schematic sectional view taken along line 111B-IIIB shown in FIG. 3A. As shown in FIG. 2, the liquid crystal display device 100 according to the embodiment has dot areas including the respective pixel electrodes 31 disposed inwardly of the respective data lines 9, the scanning lines 13, etc. As shown in FIG. 3, in each dot area, one coloring layer for one of the three primary colors is disposed, so that pixel areas including respective coloring layers 22B (blue), 22G (green), and 22R (red) are formed at three dot areas D1, D2, and D3. The portion defined by dotted lines in FIG. 3 defines the pixel area 150 shown in FIG. 1. The pixel area 150 includes, for example, the associated pixel electrode 31, TFD element 40, data line 9, and a columnar spacer or a protrusion associated with the data line 9.

Referring to the sectional structure, as shown in FIG. 3B, the liquid crystal display device 100 according to the embodiment comprises a pair of substrates 10 and 25 opposing each other via a rectangular frame-shaped sealant (not shown) and a liquid crystal layer 50 disposed between the pair of substrates 10 and 25. The liquid crystal layer 50 comprises liquid crystal which is initially aligned vertically, that is, a liquid crystal material which has a negative dielectric anisotropy. In the embodiment, a panel according to the invention is formed by the substrates 10 and 25 opposing each other via the sealant, with the liquid crystal layer 50 being sealed in the panel so as to be surrounded by the substrates 10 and 25 and the sealant.

A substrate body 10A of the lower substrate (opposing substrate) is formed of a light-transmissive material, such as quartz or glass. A reflective film 20 (metallic film formed of a metal having high reflectivity such as aluminum or silver) is formed on a part of the surface of the substrate via an insulating film 24. A color filter 22 (the red coloring layer 22R in FIG. 3B) is disposed on the area of the substrate where the reflective film 20 is not formed and the area of the substrate where the reflective film 20 is formed from thereabove. Here, the area where the reflective film 20 is formed is a reflective display area R, and the area where the reflective film 20 is not formed, that is, an opening 21 in the reflective film 20 is a transmissive display area T. Accordingly, the liquid crystal display device 100 according to the embodiment is a liquid crystal display device comprising the homeotropic liquid crystal layer 50 and is a transflective type which can provide a reflective display and a transmissive display.

A surface of the insulating film 24 formed on the substrate body 10A has an bumpy portion 24a, and a surface of the reflective film 20 is bumpy in accordance with the bumpy portion 24a. Since reflected light is scattered by the bumpy surface, external glare is prevented from occurring, so that a display with a wide viewing angle range can be achieved. The insulating film 24 having the bumpy portion 24a is formed by, for example, patterning a resin resist and applying another layer of resin thereon. In addition, the resin resist subjected to the patterning may have its form adjusted by subjecting it to heat treatment.

The color filters 22 are formed at the reflective display area R and the transmissive display area T. Edges of the coloring layers forming the color filters 22 are surrounded by a black matrix BM formed of, for example, chromium. The black matrix BM forms the boundaries of the dot areas D1, D2, and D3 (see FIG. 3A).

An insulating film 26 is further formed on the substrate body 10A in correspondence with the location of the reflective display area R. The insulating film 26 is selectively formed at the reflective display area R so as to be disposed above the reflective film 20. The formation of the insulating film 26 causes the thickness of a portion of the liquid crystal layer 50 at the reflective display area R and the thickness of a portion of the liquid crystal layer 50 at the transmissive display area T to be different. The insulating film 26 has a thickness of, for example, on the order of from 0.5 μm to 2.5 μm, and is formed of, for example, acrylic resin. Near the boundary between the reflective display area R and the transmissive display area T, the insulating film 26 has an inclined surface for continuously varying its thickness. The thickness of the liquid crystal layer 50 where the insulating film 26 is not provided is on the order of from 1 μm to 5 μm, so that the thickness of the portion of the liquid crystal layer 50 at the reflective display area R is approximately half of the thickness of the portion of the liquid crystal layer 50 at the transmissive display area T. Accordingly, the insulating film 26 functions as a liquid crystal layer thickness adjusting layer (liquid crystal layer thickness controlling layer) causing the thickness of the portion of the liquid crystal layer 50 at the reflective display area R and the thickness of the portion of the liquid crystal layer 50 at the transmissive display area T to be different by the thickness of the insulating film 26.

The common electrodes 9, formed of indium tin oxide (hereunder abbreviated as “ITO”), are formed in stripes on the insulating film 26 and the color filters 22 so as to extend perpendicularly to the plane of the figure. The common electrodes 9 are formed at respective dot areas disposed in a row perpendicular to the plane of the figure. Openings 29 for controlling liquid crystal alignment are formed in the common electrodes 9 at the transmissive display area and the reflective display area R. When these openings 29 are formed, an oblique electrical field is generated between the electrodes 9 and 31 at the opening area. In accordance with the oblique electrical field, the tilting direction of initially vertically aligned liquid crystal molecules based on voltage application is restricted, so that the alignment of the liquid crystal molecules can be controlled. In particular, since transverse electric field in the reflective display area is larger than that in the transmissive display area by an amount in correspondence with a smaller cell thickness, the restricting force on the alignment of the liquid crystal molecules is increased. The openings 29 in the common electrodes 9 are alternately formed in plan view on both sides of slits 32 (described later) in the pixel electrodes 31. As a result, the tilting direction of liquid crystal molecules LC can be alternately restricted between the openings 29 and the slits 32.

Although, in the embodiment, the reflective film 20 and the common electrodes 9 are separately formed, the reflective film (metallic film) may be used as portions of the common electrodes at the reflective display area R.

An alignment layer 37, formed of, for example, polyimide, is formed on the common electrodes 9. The alignment layer 37 acts as a vertical alignment layer for aligning the liquid crystal molecules vertically with respect to the plane of the layer, and is not subjected to an alignment operation such as rubbing.

In the upper substrate (element substrate) 25, the pixel electrodes 31 (transparent conductive films formed of, for example, ITO) are disposed in a matrix on a surface of a substrate body 25A (formed of a light-transmissive material such as glass or quartz) facing the liquid crystal layer. As in the lower substrate 10, an alignment layer 33, formed of, for example, polyimide subjected to a vertical alignment operation is formed so as to cover the pixel electrodes 31.

One pixel electrode 31 is provided at each of the dot areas D1 to D3. Voltages are separately applied to the respective dot areas D1 to D3 by the TFDs disposed at the respective dot areas. In the embodiment, a columnar spacer 51 formed of acrylic resin and used as a support along the height of the liquid crystal layer 50 is disposed so as to overlap the TFD element at the dot area D1. First protrusions 27 having a height that is less than the height of the columnar spacer 51 and having the substantially same shape as the columnar spacer 51 in plan view are disposed so as to overlap the TFD elements at the dot areas D2 and D3. Each first protrusion 27 is formed of photoresist comprising novolac resin and can be subjected to patterning by photolithography techniques. The first protrusions 27 block the electrical field from the TFD elements in order to reduce differences between liquid crystal alignments at the dot areas, and protects the TFD elements at the dot areas D2 and D3 from external pressure. Although, in the embodiment, as regards the dot areas D1 to D3 for respective color filter colors, the columnar spacer 51 is disposed at the dot area D1 and the first protrusions 27 are disposed at the dot areas D2 and D3, they may be disposed independently of the order of the colors of the color filters or randomly. In addition, although in the embodiment, the columnar spacer 51 and the first protrusions 27 are disposed so as to overlap the TFD elements, they may be disposed at areas other than where the TFD elements are disposed. In this case, although the electrical field from the TFD elements cannot be blocked, this structure is effective in reducing the difference between the liquid crystal alignments at the dot areas. It is also effective in preventing damage to the TFD elements by push pressure because the opposing substrate 10 can be supported by the first protrusions 27.

In the embodiment, second protrusions 28, formed of the same material as the first protrusions, are selectively disposed at adjacent areas in the transmissive display area T of the scanning lines 13 of the dot areas D1 to D3. The first protrusions are disposed only at the pixel areas where columnar spacers are not disposed, whereas the second protrusions are disposed at all of the pixel areas regardless of whether or not columnar spacers are provided. The second protrusions block the electrical field generated from the scanning lines. The liquid crystal molecules are vertically disposed with respect to the inclined surfaces of the second protrusions 28. Selectively forming the second protrusions at the scanning lines makes it possible to fix the disclination to a particular location.

In the embodiment, each pixel electrode 31 comprises island-shaped portions (island-shaped portions 31a and 31b in FIG. 3) and a connecting portion 39 electrically connecting the adjacent island-shaped portions 31a and 31b. Each of the island-shaped portions 31a and 31b forms a sub-dot, so that one dot comprises divided sub-dots. Although the sub-dots (island-shaped portions 31a and 31b) have regular octagonal shapes in FIG. 3A, they may be, for example, circular or polygonal. Each slit 32 is formed in a portion of its associated pixel electrode 31 (the portion excluding the associated connecting portion 39) so as to be disposed between the island-shaped portions 31a and 31b. Each slit 32 is disposed near the center between the sub-dots (island-shaped portions 31a and 31b) and between the electrode openings 29 in the substrate body 10A of the lower substrate 10 in plan view.

A retardation film 18 and a polarizer 19 are disposed at the outer surface of the lower substrate 10 (at a side opposite to the side where the liquid crystal layer 50 is sandwiched), and a retardation film 16 and a polarizer 17 are disposed at the outer surface of the upper substrate 25, so that circularly polarized light can impinge upon the inner surfaces of the respective substrates facing the liquid crystal layer 50. The retardation film 18 and the polarizer 19 and the retardation film 16 and the polarizer 17 form circularly polarizing units. The polarizers 17 and 19 are formed so as to pass only linearly polarized light having a polarization axis of a predetermined direction, and the retardation films 16 and 18 are λ/4 retardation films. Each circularly polarizing unit may comprise a combination of a polarizer, a λ/4 retardation film and a λ/2 retardation film (wide band circularly polarizing unit). In this case, it is possible to provide an achromatic color of a higher degree in a dark display. In addition, each circularly polarizing unit may comprise a combination of a polarizer, a λ/4 retardation film, a λ/2 retardation film, and a c plate (retardation film having an optical axis in the film thickness direction), so that a wider viewing angle range can be achieved. A backlight 15, which is a light source for transmissive display, is disposed at the outer side of the polarizer 19 of the lower substrate 10.

In the embodiment, the first protrusions 27 having substantially the same shape as the columnar spacer 51 in plan view are disposed so as to overlap the TFD elements at the pixel areas where columnar spacers 51 are not disposed, so that the difference between the liquid crystal alignments at the pixel areas is eliminated and the electrical field from the TFD elements is blocked in order to reduce symmetrical distortion of the electrical field in the liquid crystal layer. Therefore, it is possible to provide a liquid crystal display device providing a higher display quality. The liquid crystal display device is a transflective liquid crystal display device. In the transflective type, in order to reduce the influence of the electrical field from the TFD elements, the liquid crystal layer thickness adjusting layer 26 is formed at an area facing the TFD elements at the lower substrate 10, as a result of which the TFD elements tend to become damaged by push pressure. In the embodiment, the first protrusions protect the TFD elements, so that a more reliable structure is provided.

The above-described liquid crystal display device 100 according to the embodiment can provide the following advantages.

In the liquid crystal display device 100 according to the embodiment, since the insulating film 26 is disposed at the reflective display area R, the thickness of the portion of the liquid crystal layer 50 at the reflective display area R is substantially half of the thickness of the portion of the liquid crystal layer 50 at the transmissive display area T, so that retardation contributing to reflective display and retardation contributing to transmissive display are substantially the same, as a result of which contrast is increased.

In the embodiment, since the oblique electrical field based on the inclined surfaces of the second protrusions 28 and the openings 29 and the slits 32 can regulate the tilting direction of the liquid crystal when a voltage is applied, for example, an after image resulting from disclination or a stain-like unevenness seen when observed obliquely is not easily produced, so that a high-quality display is provided.

In the embodiment, the columnar spacer 51 and the first protrusions 27 at the TFD elements reduce the difference between the liquid crystal alignments at the pixel areas regardless of whether or not any columnar spacers are provided. In addition, electrical field generated from the TFD elements is blocked in order to reduce disturbance to the liquid crystal alignments. Further, the first protrusions 27 cover and protect the TFD elements in order to prevent damage to the elements by push pressure. Therefore, it is possible to provide a more reliable liquid crystal display device providing a high display quality.

### Second Embodiment

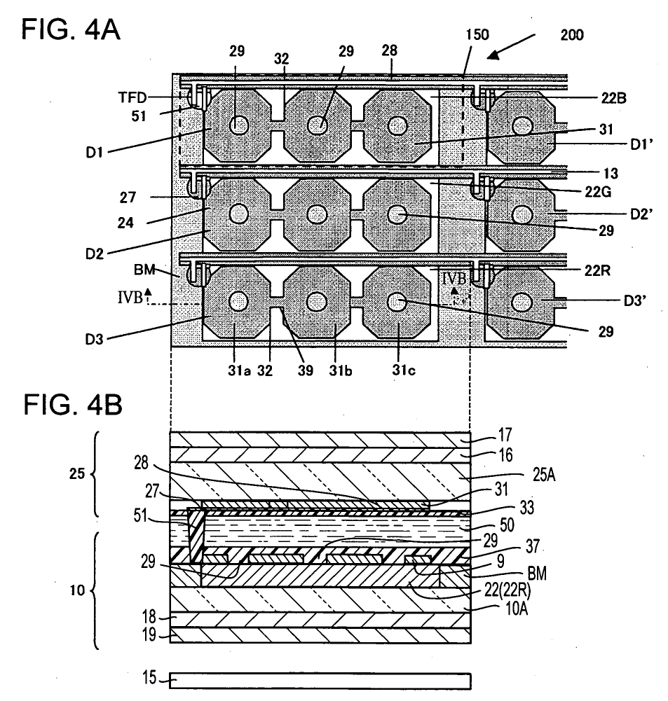

A second embodiment of the invention will be described with reference to FIGS. 4A and 4B.

FIGS. 4A and 4B are a plan view and a sectional view of a liquid crystal display device of the second embodiment, respectively, and are schematic views in correspondence with those of FIGS. 3A and 3B showing the first embodiment. Parts in the second embodiment corresponding to those in the first embodiment are given the same reference numerals.

A liquid crystal display device 200 according to the second embodiment is a transmissive liquid crystal display device which does not have a reflective display area. As shown in FIG. 4A, the liquid crystal display device 200 has dot areas including respective pixel electrodes 31 disposed inwardly of data lines 9, scanning lines 13, etc. In each dot area, one coloring layer for one of the three primary colors is disposed, so that pixel areas including respective coloring layers 22B (blue), 22G (green), and 22R (red) are formed at three dot areas D1, D2, and D3. Similarly, pixel areas including respective coloring layers 22B (blue), 22G (green), and 22R (red) are formed at dot areas D1′, D2′, and D3′ adjacent to these dot areas D1, D2, and D3 in the transverse direction with respect to the plane of the figure.

Referring to the sectional structure, as shown in FIG. 4B, the liquid crystal display device 200 according to the embodiment comprises a pair of substrates 10 and 25 opposing each other via a rectangular frame-shaped sealant (not shown) and a liquid crystal layer 50 disposed between the pair of substrates 10 and 25. The liquid crystal layer 50 comprises liquid crystal which is initially aligned vertically, that is, a liquid crystal material which has a negative dielectric anisotropy. In the embodiment, a panel according to the invention is formed by the substrates 10 and 25 opposing each other via the sealant, with the liquid crystal layer 50 being sealed in the panel so as to be surrounded by the substrates 10 and 25 and the sealant.

In the lower substrate (opposing substrate) 10, common electrodes 9, formed of ITO, are formed on a surface of a substrate body 10A, formed of a light-transmissive material such as quartz or glass. Openings 29 for controlling liquid crystal alignment are formed in the common electrodes 9.

The common electrodes 9 are disposed in the form stripes extending perpendicularly to the plane of the figure and in the respective dot areas disposed in a row perpendicularly to the plane of the figure. An alignment layer 37, formed of polyimide or the like, is formed on the common electrodes 9. The alignment layer 37 acts as a vertical alignment layer for aligning liquid crystal molecules vertically with respect to the plane of the layer, and is not subjected to an alignment operation such as rubbing.

Pixel electrodes 31 (transparent conductive films formed of, for example, ITO) are disposed in a matrix between the upper substrate body 25A and the liquid crystal layer 50. As in the lower substrate 10, an alignment layer 33, formed of, for example, polyimide subjected to a vertical alignment operation is formed so as to cover the pixel electrodes 31. Also, a color filter 22 (red coloring layer 22R in FIG. 4B) is provided at the lower substrate 10 side.

One pixel electrode 31 is provided at each of the dot areas D1 to D3 and each of the dot areas D1′ to D3′. Voltages are separately applied to the respective dot areas by TFDs disposed at the respective dot areas.

In the embodiment, a columnar spacer 51 serving as a support along the height of the liquid crystal layer 50 is disposed so as to overlap the TFD element at the dot area D1. First protrusions 27 having a height that is less than the height of the columnar spacer 51 are disposed so as to overlap the TFD elements at the dot areas D2 and D3 and D1′ to D3′. The first protrusions 27 block the electrical field from the TFD elements in order to reduce differences between liquid crystal alignments at the dot areas, and protect the TFD elements at the dot areas D2 and D3 from external pressure. Although, in the embodiment, the columnar spacer 51 and the first protrusions 27 are disposed so as to overlap the TFD elements, they may be disposed at areas other than where the TFD elements are disposed. In this case, although the electrical field from the TFD elements cannot be blocked, this structure is effective in reducing the difference between the liquid crystal alignments at the dot areas. It is also effective in preventing damage to the TFD elements by push pressure because the opposing substrate 10 can be supported by the first protrusions 27.

In the embodiment, second protrusions 28 are disposed entirely at the scanning lines 13 at the dot areas D1 to D3 and the dot areas D1′ to D3′. At the pixel areas where the first protrusions are disposed, the first protrusions and the second protrusions are connected, so that an electrical field generated from the scanning lines is more effectively blocked than in the first embodiment. In addition, the liquid crystal molecules can be disposed perpendicularly to inclined surfaces of the second protrusions 28. The first and second protrusions are formed at the same time by the same process, so that the cost burden in the second embodiment is less than that in the first embodiment.

In the embodiment, each pixel electrode 31 comprises island-shaped portions (island-shaped portions 31a, 31b, and 31c in FIG. 4) and connecting portions 39 electrically connecting the adjacent island-shaped portions. Each of the island-shaped portions 31a, 31b, and 31c forms a sub-dot, so that one dot comprises divided sub-dots. Although the sub-dots (island-shaped portions 31a, 31b, and 31c) have octagonal shapes in FIG. 4A, they may be, for example, circular or polygonal. Slits 32 are formed in portions of the associated pixel electrode 31 (the portions excluding the connecting portions 39) so as to be disposed between the island-shaped portions 31a and 31b and island-shaped portions 31b and 31c. The slits 32 are disposed near the center between the sub-dots (island-shaped portions 31a and 31b and island-shaped portions 31b and 31c) and between the electrode openings 29.

A retardation film 18 and a polarizer 19 are disposed at the outer surface of the lower substrate 10 (at a side opposite to the side where the liquid crystal layer 50 is sandwiched), and a retardation film 16 and a polarizer 17 are disposed at the outer surface of the upper substrate 25, so that circularly polarized light can impinge upon the inner surfaces of the respective substrates facing the liquid crystal layer 50. The retardation film 18 and the polarizer 19 and the retardation film 16 and the polarizer 17 form circularly polarizing units. The polarizers 17 and 19 are formed so as to pass only linearly polarized light having a polarization axis of a predetermined direction, and the retardation films 16 and 18 are λ/4 retardation films. Each circularly polarizing unit may comprise a combination of a polarizer, a λ/4 retardation film and a λ/2 retardation film (wide band circularly polarizing unit). In this case, it is possible to provide an achromatic color of a higher degree in a dark display. In addition, each circularly polarizing unit may comprise a combination of a polarizer, a λ/4 retardation film, a λ/2 retardation film, and a c plate (retardation film having an optical axis in the film thickness direction), so that a wider viewing angle range can be achieved. A backlight 15, which is a light source for transmissive display, is disposed at the outer side of the polarizer 19 of the lower substrate 10.

As in the first embodiment, even in the second embodiment, the first protrusions 27 having substantially the same shape as the columnar spacer 51 in plan view are disposed so as to overlap the TFD elements at the pixel areas where columnar spacers 51 are not disposed, so that the difference between the liquid crystal alignments at the pixel areas is eliminated and the electrical field from the TFD elements is blocked in order to reduce symmetrical distortion of the electrical field in the liquid crystal layer 50. Therefore, it is possible to provide a liquid crystal display device providing a higher display quality. Since the first protrusions 27 protect the TFD elements, the TFD elements are prevented from becoming damaged due to external pressure such as push pressure, so that the structure of the liquid crystal display device according to the second embodiment is highly reliable.

Unlike the liquid crystal display device according to the first embodiment, the liquid crystal display device according to the second embodiment is a transmissive type. Therefore, the first and second protrusions 27 and 28 can easily be formed at the same time, thereby considerably reducing costs. In addition, since the first and second protrusions 27 and 28 are formed at the same time, they can be easily joined together, so that the electrical field generated from the TFD elements and the scanning lines 13 can be effectively blocked, thereby improving the line-of-flow property of the internal structure of the liquid crystal layer 50.

In the second embodiment, since one columnar spacer 51 is disposed at one of the six dot areas D1 to D3 and D1′ to D3′, resiliency with respect to external shock is increased and failure due to bubbles is less likely to occur. In addition, since the first protrusions 27 protect the TFD elements, the TFD elements are not damaged, so that a more reliable liquid crystal display device can be provided.

### Third Embodiment

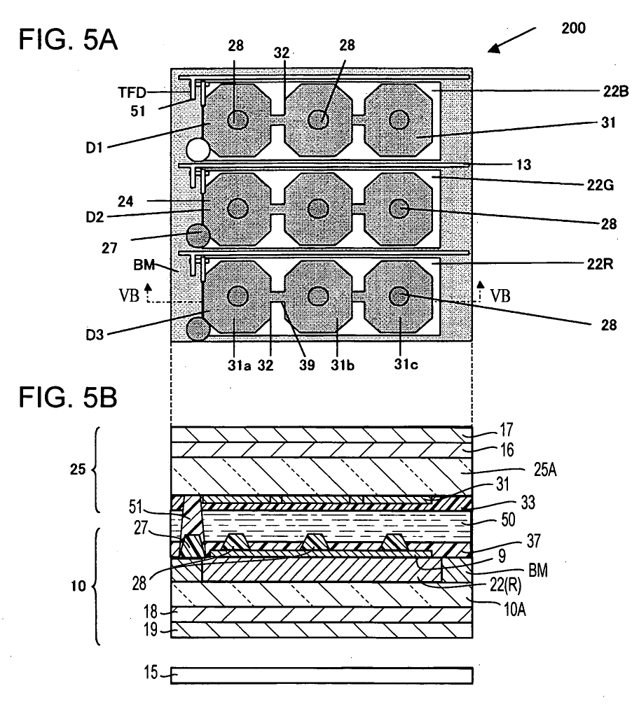

A third embodiment of the invention will be described with reference to FIGS. 5A and 5B.

FIGS. 5A and 5B are a plan view and a sectional view of a liquid crystal display device of the third embodiment, respectively, and are schematic views in correspondence with those of FIGS. 3A and 3B showing the first embodiment. Parts in the third embodiment corresponding to those in the first embodiment are given the same reference numerals.

A liquid crystal display device 200 according to the third embodiment is a transmissive liquid crystal display device which does not have a reflective display area. As shown in FIG. 5A, the liquid crystal display device 200 has dot areas including respective pixel electrodes 31 disposed inwardly of data lines 9, scanning lines 13, etc. In each dot area, one coloring layer for one of the three primary colors is disposed, so that pixel areas including respective coloring layers 22B (blue), 22G (green), and 22R (red) are formed at three dot areas (D1, D2, and D3).

Referring to the sectional structure, as shown in FIG. 5B, the liquid crystal display device 200 according to the embodiment comprises a pair of substrates 10 and 25 opposing each other via a rectangular frame-shaped sealant (not shown) and a liquid crystal layer 50 disposed between the pair of substrates 10 and 25. The liquid crystal layer 50 comprises liquid crystal which is initially aligned vertically, that is, a liquid crystal material which has a negative dielectric anisotropy. In the embodiment, a panel according to the invention is formed by the substrates 10 and 25 opposing each other via the sealant, with the liquid crystal layer 50 being sealed in the panel so as to be surrounded by the substrates 10 and 25 and the sealant.

In the lower substrate (opposing substrate) 10, common electrodes 9, formed of ITO, are formed on a surface of a substrate body 10A, formed of a light-transmissive material such as quartz or glass.

The common electrodes 9 are disposed in the form of stripes extending perpendicularly to the plane of the figure and in the dot areas disposed in a row perpendicularly to the plane of the figure. An alignment layer 37, formed of polyimide or the like, is formed on the common electrodes 9. The alignment layer 37 acts as a vertical alignment layer for aligning liquid crystal molecules vertically with respect to the plane of the layer, and is not subjected to an alignment operation such as rubbing.

Pixel electrodes 31 (transparent conductive films formed of, for example, ITO) are disposed to in between the upper substrate body 25A and the liquid crystal layer 50. As in the lower substrate 10, an alignment layer 33, formed of, for example, polyimide subjected to a vertical alignment operation is formed so as to cover the pixel electrodes 31. Also a color filter 22 (red coloring layer 22R in FIG. 5B) is provided at the lower substrate 10 side.

One pixel electrode 31 is provided at each of the dot areas D1 to D3. Voltages are separately applied to the respective dot areas by TFDs disposed at the respective dot areas.

In the embodiment, at the dot area D1, a columnar spacer 51 serving as a support along the height of the liquid crystal layer 50 is disposed in a gap between the pixel electrode and an adjacent pixel electrode. First protrusions 27 having a height that is less than the height of the columnar spacer 51 are disposed in the gaps between the pixel electrodes at the dot areas D2 and D3. Although the first protrusions 27 cannot block the electrical field from the TFD elements as they do in the first and second embodiments, they are effective in reducing differences between liquid crystal alignments at the dot areas. In addition, they are effective in preventing damage to the TFD elements by push pressure because the opposing substrate 10 can be supported by the first protrusions 27.

In the embodiment, second protrusions 28 for controlling alignment are disposed so as to overlap the pixel electrodes 31 at the dot areas D1 to D3. In the embodiment, the second protrusions 28 are provided in place of the openings 29 in the first and second embodiments, and have an alignment restricting force of an azimuthal component that is higher than that resulting from the alignment control by the openings. By virtue of this structure, the diameters of the second protrusions are smaller than when the openings are formed, so that the area of the pixel electrodes used for a displaying operation can be made wider. As a result, a liquid crystal display device providing a brighter display can be provided. The first and second protrusions are formed at the same time by the same process, so that the cost burden in the third embodiment is less than that in the first embodiment.

In the embodiment, each pixel electrode 31 comprises island-shaped portions (island-shaped portions 31a, 31b, and 31c in FIG. 5) and connecting portions 39 electrically connecting the adjacent island-shaped portions. Each of the island-shaped portions 31a, 31b, and 31c forms a sub-dot, so that one dot comprises divided sub-dots. Although the sub-dots (island-shaped portions 31a, 31b, and 31c) have octagonal shapes in FIG. 5A, they may be, for example, circular or polygonal. Slits 32 are formed in portions of the associated pixel electrode 31 (the portions excluding the connecting portions 39) so as to be disposed between the island-shaped portions 31a and 31b and island-shaped portions 31b and 31c. The slits 32 are disposed near the center between the sub-dots (island-shaped portions 31a and 31b and island-shaped portions 31b and 31c) and between electrode openings 29.

A retardation film 18 and a polarizer 19 are disposed at the outer surface of the lower substrate 10 (at a side opposite to the side where the liquid crystal layer 50 is sandwiched), and a retardation film 16 and a polarizer 17 are disposed at the outer surface of the upper substrate 25, so that circularly polarized light can impinge upon the inner surfaces of the respective substrates facing the liquid crystal layer 50. The retardation film 18 and the polarizer 19 and the retardation film 16 and the polarizer 17 form circularly polarizing units. The polarizers 17 and 19 are formed so as to pass only linearly polarized light having a polarization axis of a predetermined direction, and the retardation films 16 and 18 are λ/4 retardation films. Each circularly polarizing unit may comprise a combination of a polarizer, a λ/4 retardation film and a λ/2 retardation film (wide band circularly polarizing unit). In this case, it is possible to provide an achromatic color of a higher degree in a dark display. In addition, each circularly polarizing unit may comprise a combination of a polarizer, a λ/4 retardation film, a λ/2 retardation film, and a c plate (retardation film having an optical axis in the film thickness direction), so that a wider viewing angle range can be achieved. A backlight 15, which is a light source for transmissive display, is disposed at the outer side of the polarizer 19 of the lower substrate 10.

In the third embodiment, the first protrusions 27 having substantially the same shape as the columnar spacer 51 in plan view are disposed in the gaps at the pixel areas where columnar spacers 51 are not disposed, so that the difference between the liquid crystal alignments at the pixel areas is eliminated. Therefore, it is possible to provide a liquid crystal display device providing a higher display quality. The first protrusions 27 act as supports and thus prevent the TFD elements from becoming damaged by external pressure such as push pressure. Therefore, the structure of the liquid crystal display device according to the third embodiment is highly reliable.

Electronic Apparatus

A specific example of an electronic apparatus comprising the liquid crystal display device according to any one of the embodiments of the invention will be described.

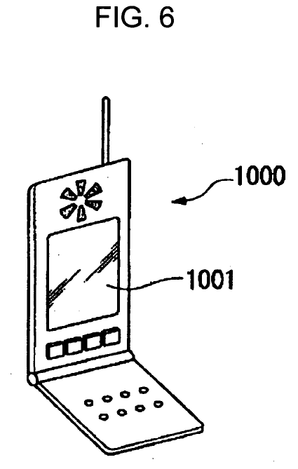

FIG. 6 is a perspective view of an example of a cellular phone. In FIG. 6, reference numeral 1000 denotes a cellular phone body and reference numeral 1001 denotes a display unit using any one of the above-described liquid crystal display devices. When the liquid crystal display device according to any one of the aforementioned embodiments is used in the display unit of the electronic apparatus such as a cellular phone, the electronic apparatus comprises a liquid crystal display unit which provides a highly reliable bright display having a high contrast and a wide viewing angle range regardless of the environment in which the apparatus is used.

The liquid crystal display device according to any one of the aforementioned embodiments may be suitably used as image displaying means not only in the cellular phone but also in an electronic book, a personal computer, a digital still camera, a liquid crystal television, a view finder or a monitor direct viewing video tape recorder, a car navigation system, a pager, an electronic notebook, a calculator, a word processor, a work station, a television telephone, a POS terminal, or a touch panel. Therefore, any of these electronic apparatuses can provide a highly reliable display having a high contrast and a wide viewing angle range.

The technical scope of the invention is not limited to the above-described embodiments, so that various modifications may be made without departing from the gist of the invention.

Although, in the above-described embodiments, the invention is applied to an active matrix liquid crystal display device using TFDs as switching elements, the invention is also applicable to, for example, an active matrix liquid crystal display device using TFTs as switching elements and to a passive matrix liquid crystal display device.

What is claimed is:

1. A liquid crystal display device comprising:
a pair of opposing substrates;
a liquid crystal layer disposed between the pair of substrates, the liquid crystal layer being formed of liquid crystal which has a negative dielectric anisotropy and which is vertically aligned in an initial alignment state;
pixels disposed in a matrix within an area of one of the pair of substrates, each pixel including a pixel electrode, a gap between the pixel electrode of the pixel and the pixel electrode of an adjacent pixel, a switching element connected to the pixel electrode, and a metal line connected to the switching element, the pixels including a first pixel and a second;
a columnar spacer that separates the opposing substrates, the spacer being disposed at a position of the first pixel that corresponds to the gap of the first pixel or in overlap with the switching element of the first pixel; and
a first protrusion having a height that is less than the height of the spacer and that is disposed at a position of the second pixel that corresponds to the position of the first pixel where the spacer is disposed.

2. The liquid crystal display device according to claim 1, wherein the spacer has an area in plan view that is substantially the same as an area in plan view of the first protrusion.

3. The liquid crystal display device according to claim 1, wherein the spacer and the first protrusion are disposed on the same substrate.

4. The liquid crystal display device according to claim 1, wherein the spacer overlaps the switching element of the first pixel and the first protrusion overlaps the switching element of the second pixel.

5. The liquid crystal display device according to claim 1, wherein a second protrusion is disposed in overlap with the metal lines or the pixel electrode of a third pixel of the pixels, the second protrusion tilting the liquid crystal in the initial alignment state.

6. The liquid crystal display device according to claim 5, wherein the first protrusion and the second protrusion being formed from the same material and having substantially the same height.

7. The liquid crystal display device according to claim 5, wherein the second protrusion is disposed in overlap with a signal line or with a scanning line connected to the switching element of the corresponding pixel.

8. The liquid crystal display device according to claim 1, wherein each pixel includes a transmissive display area and a reflective display area, and further comprising a liquid crystal layer thickness adjusting layer disposed between the liquid crystal layer and one of the substrates, the liquid crystal layer thickness adjusting layer narrowing thickness of the liquid crystal layer at reflective display areas smaller to less than thickness of the liquid crystal layer at the transmissive display areas.
